(19) United States
(12) Patent Application Publication
(10) Pub. No.: US 2006/0069493 A1
(43) Pub. Date: Mar. 30, 2006

(54) Method of operating an internal combustion engine

(76) Inventors: Patrick Attard, Naxxar (MT); Ruediger Herweg, Esslingen (DE); Matthias Pfau, Ludwigsburg (DE); Benoit Salvant, Carantec (FR); Joohen Schaeflein, Stuttgart (DE)

Correspondence Address: KLAUS J. BACH, 4407 TWIN OAKS DRIVE, MURRYSVILLE, PA, 15668, US

(21) Appl. No.: 11/234,068

(22) Filed: Sep. 23, 2005

(30) Foreign Application Priority Data
Sep. 25, 2004 (DE) 102004046647.5

(51) Int. Cl. G06F 17/00; F02M 7/00

(52) U.S. Cl. 701/106; 701/114; 123/435

(57) ABSTRACT

In a method for operating an internal combustion engine, a control operation is provided for the combustion process, wherein an actual value of the crank angle of a 50% mass conversion point of the fuel to be converted during the combustion is determined taking into account a measurement signal of an ion current sensor which is arranged in a combustion chamber, and the crank angle of the 50% mass conversion point is adjusted to a set point value of the position of the 50% mass conversion point by varying at least one manipulated variable of the internal combustion engine which affects the combustion. The crank angle of the 50% mass conversion point is determined in a layered neural network in which the measurement results of the ion current sensor are logically combined with at least one further, continuously measured operating parameter of the internal combustion engine.

### BACKGROUND OF THE INVENTION

The invention relates to a method for operating an internal combustion engine, wherein the combustion process in the combustion chambers is controlled in that the crank angle for a 50% mass conversion point is determined taking into consideration the measurement signal of an ion current sensor arranged in the combustion chamber and the actual 50% mass conversion point is corrected to a certain desired value.

It is known that in internal combustion engines the combustion behavior of the fuel/air charge in the combustion chamber decisively influences the efficiency of the internal combustion engine and the emission of pollutants as well as the consumption of fuel. A stable and reliable ignition and combustion however must therefore be ensured also because of strict legal emission limits. For this reason, in particular in the case of auto-ignition operating methods it is necessary to control the combustion behavior. DE 198 04 988 C1 discloses a method for operating an internal combustion engine with direct injection and combustion of homogeneous, lean air/fuel mixtures with compression ignition. In this procedure the mixtures are made to auto-ignite by means of compression heat. In order to control the combustion behavior, the respective combustion process must be measured and for controlling the combustion as a function of the signal acquired from this measurement, the inlet valve for the next cycle of the respective cylinder must be adjusted by an adjustable valve drive. In order to measure and detect undesired combustion processes, the position and the profile of the combustion should be measured in real time by means of actual engine operating values such as the body-transmitted engine sound at the internal combustion engine, the ion current in the combustion chamber or the non-congruence of the crankshaft. The acquired measurement signals relating to the profile of the combustion are compared with set point parameters which are stored in characteristic performance graphs. The control logic which is provided for this purpose is intended to detect the features of desired and undesired combustion ranges by detecting patterns by means of neural networks or adaptive regulators and to determine, using the engine operating actual values, the set point values which are necessary for the operation of the gas exchange valves.

WO 03/085244 A1 discloses a method for operating an internal combustion engine with compression ignition, in which a regulating operation of the combustion is provided during which the position of a 50% mass conversion point of the current combustion is used as a regulating variable, that is to say the time at which 50% of the mass of fuel injected into the combustion chamber is converted during a combustion cycle or working cycle of the respective cylinder. In order to determine the position of the 50% mass conversion point in the combustion process, an ion current signal is sensed by means of an ion current probe which is arranged in the combustion chamber. In the known method, the ion current signal is integrated in order to determine the actual value of the 50% mass conversion point. The signal profile is summed or integrated, with the maximum integral or the total corresponding to 100% conversion of the mass of fuel which has taken part in the combustion in the respective cycle. Then, the determined actual value of the position of the 50% mass conversion point of the current combustion process is compared with the value which is stored in a control unit. In a subsequent working cycle, the sequence of combustion is changed by adapting operating parameters for optimal combustion. The known method proposes, for the purpose of setting the 50% mass conversion point, that operating parameters such as valve control times of the gas exchange valves or of the injection of fuel be changed. In this context, mixture of characteristic variables such as the residual gas proportion in the combustion chamber, the air ratio or the mixture temperature in the combustion chamber can be varied or even the quantity of gas which is retained in the combustion chamber for compression ignition can be varied.

It is the object of the present invention to provide a method for operating an internal combustion engine of the type referred to above with which an accurate control process for the control of the combustion behavior and thus, in particular in the compression ignition operating mode, for optimum combustion of fuel is made possible with little expenditures.

### SUMMARY OF THE INVENTION

In a method for operating an internal combustion engine, a control operation is provided for the combustion process, wherein an actual value of the crank angle of a 50% mass conversion point of the fuel to be converted during the combustion is determined taking into account a measurement signal of an ion current sensor which is arranged in a combustion chamber, and the crank angle of the 50% mass conversion point is adjusted to a set point value of the position of the 50% mass conversion point by varying at least one manipulated variable of the internal combustion engine which affects the combustion. The crank angle of the 50% mass conversion point is determined in a layered neural network in which the measurement results of the ion current sensor are logically combined with at least one further, continuously measured operating parameter of the internal combustion engine.

With this method, an accurate control operation is carried out by adjusting the position of the 50% mass conversion point in that the present actual value of the crank angle of the 50% mass conversion point is determined by a neural network system, in that the measurement results of the ion current sensor in the combustion chamber are logically combined with at least one further, continuously measured operating parameter of the internal combustion engine. In order to acquire the desired definitive information about the position of the 50% mass conversion point, input values which are distributed chronologically over the cycle of the cylinder are determined from the measurement signal of the ion current sensor and are weighted with weighting factors and logically combined by means of neurons of the neural network. The weighting factors which are decisive for the accuracy of the determination of the actual value can be modified in the neural network with a trainable algorithm. Such training of the neural network with respect to the accuracy of the determination of the actual value of the position of the 50% mass conversion point is expediently provided over a predetermined number of cylinder cycles. The neural network expediently has a hidden layer whose neurons ensure an improvement in the accuracy when determining the optimum weighting factors. In this context it has become apparent that, given all the trainable algorithms which are taken into account for training the neural network, the best possible accuracy with a reliability of over 90% of fault-free results within a range of 0.50 CA is obtained with a hidden layer with seven neurons.

The accuracy of the determination of the actual value of the crank angle of the 50% mass conversion point can be increased if a plurality of continuously measured operating parameters are input into the neural network in order to determine the weighting factors. With the method according to the invention it is possible to acquire the ratio of the achieved level of accuracy to the outlay necessary to acquire it and to determine the point from where an increase in the outlay by the use of additional operating parameters no longer perceptibly improves the result. For the duration of the training operation, approximately 100 cycles of the cylinder is considered to be the lower limit at which a sufficiently high accuracy level of the results can be obtained. The method according to the invention provides for training with a duration of less than 600 cycles, as it has become apparent that above this maximum an improvement in the accuracy no longer justifies the outlay which it requires. Optimum results are achieved with a approximately 350 cycles for the training operation. After a training operation of the neural network, a validation phase is advantageously provided, during which the efficiency or the accuracy of the neural network is evaluated using the determined weighting factors. However, it is sufficient here if the validation is carried out over approximately the same number of cylinder cycles as the preceding training of the neural network.

The training of the neural network is preferably carried out for various operating points of the internal combustion engine with the weighting factors being calibrated in order to weight the standardized input signals of the neural network.

The accuracy of the neural network in relation to the outlay for feeding and operating parameters may be decisively influenced by the number of discrete over time input values which are acquired by forming a pattern from the measurement signal of the ion current sensor. In this context, when there are more than 36 inputs the expense for the control technology becomes too large and the accuracy of the results is no longer perceptibly influenced. A pattern of 13 input values has proven sufficiently accurate in relation to the outlay which it requires.

In an advantageous embodiment of the invention with a hidden layer, a sigmoidal function of the logically combined input values is input into the neurons of the hidden layer and a linear function is provided at the output neuron from which the deviation of the actual value of the crank angle of the 50% mass conversion point can easily be derived.

The measurement signal of a lambda sensor can advantageously be used to determine the weighting factors. It is possible to determine, for example, the oxygen content in the exhaust gas as obtained from the lambda sensor as an operating parameter of the internal combustion engine. It is also possible to determine the quantity of the fresh gas contained in the combustion chamber as such an operating parameter. Informative weighting factors can also be acquired on the basis of the measurement signal of temperature sensors, in which case it is also possible to use the temperature of the intake air or of the exhaust gas of the internal combustion engine depending on the corresponding arrangement of the temperature sensors. By training the neural network with the standardized ion current signals of the cylinders and outputs of other sensors such as the lambda sensor or the temperature sensor the point of maximum combustion or of minimum emissions becomes can be very accurately determined.

In order to act on the actual value of the position of the 50% mass conversion point within the scope of the control operation, at least one parameter of the internal combustion engine which influences the combustion is acted on. In this context, actuating elements with an effect on the fresh gas component in the mixture and/or the injection of fuel are preferably varied. In this context it is possible to act on the mass flow rate in the inlet ducts, for example by correspondingly actuating throttle valves, or particularly advantageously by correspondingly varying the setting of a variable adjustable gas exchange control. By correspondingly changing the variable valve drive of the inlet valves it is possible to set the fresh gas supply correspondingly. A swirl flow of the inflowing combustion air is particularly advantageously varied as a parameter which influences the combustion behavior, for example by adjusting the valve drive of one of two inlet ducts. It has also proven advantageous to change the control times of the outlet valve as a manipulative variable of the regulating process, as a result of which the quantity of exhaust gas retained in the combustion chamber can be adjusted. The quantity of the injected fuel or the injection time can be varied or set by changing the injection pressure, individually or if appropriate in combination, as advantageous control measures which affect the injection of fuel. It is also possible to set the actual value of the crank angle of the 50% mass conversion point by varying the injection parameters of a pilot injection which precedes the main injection, in which case the capability of the mixture to ignite can be greatly influenced by appropriately setting the pilot injection.

An exemplary embodiment of the invention is explained in more detail below with reference to the accompanying drawings:

### BRIEF DESCRIPTION OF THE DRAWINGS

FIG. 1 shows schematically a direct injection internal combustion engine,

FIG. 2 shows schematically the feeding of the neural network, and

FIG. 3 is a diagram showing the determination of the position of the 50% mass conversion point from ion current signals with a neural network.

### DESCRIPTION OF A PARTICULAR EMBODIMENT OF THE INVENTION

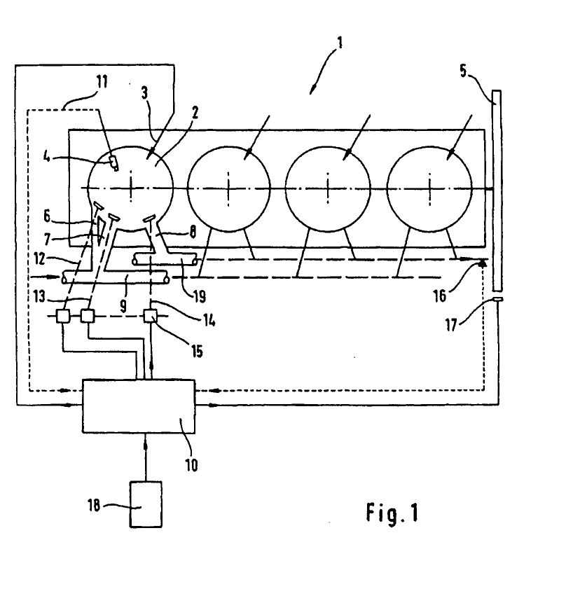

FIG. 1 shows a direct injection internal combustion engine 1 with four cylinders 2 in which longitudinally displaceable pistons which act together on a crankshaft 5 are arranged. Each cylinder 2 is equipped with an injector 3 which injects fuel directly into the combustion chamber which is formed in the cylinder 2. A fuel/air mixture is formed in the combustion chamber with the injected fuel and fresh gas which is supplied separately through inlet ducts 6, 7, and is burnt in order to drive the crankshaft. The combustion exhaust gases are discharged from the combustion chamber through outlet ducts 8. The inlet ducts 6, 7 and the outlet ducts 8 of the cylinders are each provided with gas exchange valves 12, 13, 14 which are actuated by a valve drive 15 in order to carry out the cyclical gas exchanges in the respective cylinder 2. In the present exemplary embodiment, two inlet passages 6, 7 are provided per cylinder 2, an inlet passage 6 opening tangentially into the combustion chamber and thus being able to trigger a swirl flow around the cylinder axis. Air is supplied to the inlet passages 6, 7 of all the cylinders are fed from a common intake manifold 9. The outlet passage 8 of the cylinder 2 open into a common exhaust line 19 from which the exhaust gases are discharged into the ambient air, possibly after flowing through an exhaust gas treatment device.

Furthermore, a spark plug 4 which provides an ignition spark between a plurality of electrodes is provided in each combustion chamber in order to ignite the mixture formed in the combustion chamber. The spark ignition operating mode wherein ignition is triggered by sparks is provided for relatively high load ranges, while an operating mode with compression ignition is provided for medium and lower load engine operating ranges, wherein homogenous, lean mixtures are formed and are made to auto-ignite. The auto-ignition takes place here as a result of compression of the mixture by the piston, with provisions for the combustion chamber temperature to be raised by retaining exhaust gas from the respectively preceding combustion process in the cylinder in order to facilitate the auto-ignition during the combustion of fuel in a spark ignition engine. The flow of fresh gas entering the combustion chamber and also the quantity of retained exhaust gas is determined by the control times of the gas exchange valves and this can be adjusted by means of a variable valve drive of the gas exchange valves. Such adjustable valve drives may be, for example, cam valve drives with phase actuators for changing the phase angle of the opening processes. By correspondingly changing the control times of the inlet valves 6, 7 it is possible both to set the quantity of inflowing fresh gas and to set the severity of swirl of the inflowing fresh gases around the cylinder axis.

The actuating elements which are decisive for the formation of the mixture in the combustion chamber are controlled by a control unit 10 for which a performance graph memory 18 for reading out data as required is provided in order to set the injection parameters for the injection of fuel and to provide the optimum setting of the control times of the gas exchange valves. The control unit 10 analyses the respective combustion process in the cylinders 2 and controls the combustion so as to occur at a predefined set point value in order to ensure optimum combustion. When the result of the combustion analysis deviates from a predefined set point value, the control unit generates corresponding correction instructions for actuating means which influence the combustion behavior. The settings of the injection parameters for the injector 3 or the adjustable valve drive or even a combination of various measures may be used as such actuating means. The control variable of the control procedure is formed by the time of conversion of half of the injected fuel during the combustion, referred to as the 50% mass conversion point. The actual value of the 50% mass conversion point which is determined is adjusted by the control unit to a predetermined set point value by correspondingly varying the manipulated variables. In order to determine the actual value of the 50% mass conversion point, an ion current signal 11 is supplied to the control unit 10. As the ion current sensor the spark plug 4 of the respective cylinder 2 is used which projects into the combustion chamber and senses the time-dependent ion current values.

In order to determine the actual value of the crank angle of the 50% mass conversion point, the ion current signal 11 is logically combined with at least one further, continuously measured operating parameter of the internal combustion engine in a neural network. In order to acquire such operating parameters, a sensor 17 is provided on the crankshaft 5 in the present exemplary embodiment. This sensor can be used to provide the respective rotational speed or the momentary torque as an operating parameter for logical combination with the ion current signal of the control unit 10. At the input side of the control unit 10, a lambda probe 16 is provided in the exhaust line 19 of the internal combustion engine 1 in order to acquire measured operating parameters for feeding to the neural network.

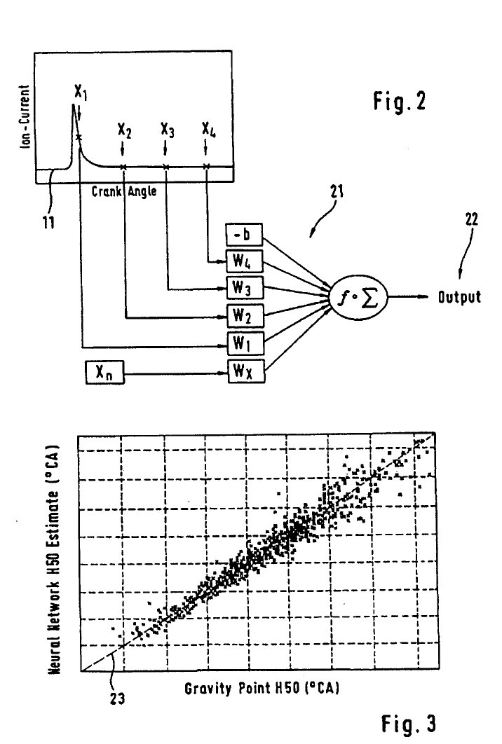

The determination of the actual value of the position of the 50% mass conversion point as a control variable 22 as an output of the neural network is illustrated in FIG. 2. The neural network 21 is trained with input values x₁₋ₙ, which are acquired from the ion current signal 11 obtained in the combustion chamber, and with input values b of at least one further operating parameter, in order to detect the crank angle of the 50% mass conversion point. The input values are acquired from the measurement signal 11 of the ion current sensor in such a way that they are distributed chronologically over the cycle of the cylinder, with input values i₁₋ₓ which are discrete over time and whose time intervals are identical according to the present exemplary embodiment 13. In order to facilitate greater efficiency of the neural network and more accurate acquisition of the control variable, it may, however, also be expedient to form patterns with more input values or else to provide different intervals between the input values which are discrete over time. It is possible, for example, to increasingly remove input values at characteristic points of the signal profile. A standardized input value which is weighted in the neural network with a weighting factor w₁-wₓ which is assigned to the respective input value is formed at the ion current values corresponding to the signal 11 at the respective points. The weighting factors w₁-wₓ are modified by training the neural network 21, with the possibility of randomly generated weighting factors w₁-wₓ being used as the basis at the start of the training of the neural network and being finely adjusted by logical combination of the measured operating parameters b of the internal combustion engine. The weighting factors w₁-wₓ are finely calibrated by training the neural network 21 for various operating points of the internal combustion engine. The output signal 22 of the neural network is used as the basis of the actual value of the crank angle of the 50% mass conversion point for the control of the combustion behavior of the internal combustion engine.

The weighting factors w₁-wₓ are modified with a trainable algorithm within the scope of the training of the neural network 21. In this process an error rate of the deviations of actual measurements from the ideal value can be reduced by an increasing number of repetitions (iterations) of the modification process of the weighting factors. It has become apparent that when there are more than 600 iterations it is virtually impossible to improve the error rate and convergence occurs at approximately 1000 repetitions.

In the present exemplary embodiment, the neural network is provided with a hidden layer in which the algorithm for modifying the weighting factors is implemented. In neurons of the hidden layer, the weighted input values are transformed in a summed form as a sigmoid function after further weighting and summing of a linear function to form the output signal. In this context, optimum accuracy of the modification in comparison to the outlay is achieved with a hidden layer with 7 neurons, and high reliability and accuracy values above 90% error-free results are obtained within 0.5° crank angle with all the possible algorithms for modifying the weighting factors.

FIG. 3 is a diagram illustrating the linear function 23 at the output of the neural network of the hidden layer by a dashed line. The results of the positions of the 50% mass conversion point which are determined by weighting the standardized ion current signal are entered in accordance with the respective crank angle by means of the crosses. The weighting factors which are assigned to the respective measurement results are modified in accordance with the deviation or distance of the points marked by the crosses from the optimum linear function 23 and are used as the basis for the further combustion processes within the scope of the training of the neural network.

What is claimed is:

1. A method of operating an internal combustion engine (1) having cylinders (2) with combustion chambers and at least one inlet passage (6, 7) per cylinder (2), said method comprising the steps of supplying fresh gas and fuel to the combustion chamber to form therein a fuel/air mixture with the fresh gas and the fuel which is directly injected into the combustion chambers, igniting the mixture in the combustion chambers so as to be burnt, and discharging the combustion exhaust gases from the combustion chamber through at least one outlet passage (8), providing a control operation for the combustion process, and determining the actual value of the crank angle of the 50% mass conversion point (H 50) by a layered neural network (21) in which the measurement results of an ion current sensor (4) arranged in the combustion chamber are logically combined with at least one further continuously measured operating parameter of the internal combustion engine (1).

2. The method as claimed in claim 1, wherein input values (I₁₋ₓ) which are distributed chronologically over the cycle of the cylinder (2) are acquired from the measurement signal (11) of the ion current sensor (4) and are weighted with weighting factors (W₁₋ₓ) and logically combined by means of neurons of the neural network (21) and provided as an actual value of the position of the 50% mass conversion point (H₅₀).

3. The method as claimed in claim 2, wherein a training operation of the neural network (21), during which the weighting factors (W₁₋ₓ) are continuously calculated with a trainable algorithm and modified with respect to the accuracy of the determination of the actual value of the position of the 50% mass conversion point (H 50), is provided over a predetermined number of cylinder cycles.

4. The method as claimed in claim 3, wherein the neural network (21) is trained over 100 to 600 cylinder cycles, preferably 350 cycles.

5. The method as claimed in claim 1, wherein the weighting factors (W₁-Wₓ) are calibrated by training the neural network (21) for various operating points of the internal combustion engine (1).

6. The method as claimed in claim 3, wherein the neural network (21) is trained with a plurality of measured parameters.

7. The method as claimed in claim 2, wherein the neural network (21) is provided with a hidden layer.

8. The method as claimed in claim 7, wherein a plurality of neurons, preferably 7, are provided in the hidden layer.

9. The method as claimed in claim 7, wherein the logically combined input values (I₁₋ₓ) of the neural network (21) are provided in a sigmoid function of the hidden layer and transformed to form a linear function (23).

10. The method as claimed in claim 1, wherein standardized input values for the neural network (21) are formed from the ion current signal (11).

11. The method as claimed in claim 3, wherein, after a training operation of the neural network (21), a validation phase is provided during which the efficiency of the neural network is evaluated using the determined weighting factors (W₁₋ₓ).

12. The method as claimed in claim 11, wherein the validation is carried out over approximately the same number of cylinder cycles as the training of the neural network (21).

13. The method as claimed in claim 1, wherein the internal combustion engine (1) is operable in a spark ignition mode with ignition of the fuel/air mixture by means of a spark plug, and an operating mode with compression ignition in which auto-ignition of the mixture takes place is provided in at least part of the load range.

14. The method as claimed in claim 1, wherein a spark plug (4) of the respective cylinder (2) is used as the ion current sensor.

15. The method as claimed in claim 1, wherein operating parameters supplied to the neural network (21) are determined from the measurement signal of a lambda sensor (16).

16. The method as claimed in claim 1, wherein operating parameters supplied to the neural network (21) are determined from the measurement signal of temperature sensors.

17. The method as claimed in claim 1, wherein in order to set the set point value of the crank angle of the 50% mass conversion point, actuating elements which affect at least one of the fresh gas component in the mixture and the injection of fuel are actuated.

18. The method as claimed in claim 17, wherein in order to set the desired combustion behavior in the respective combustion chamber (2) the mass flow rate in the inlet ducts (6, 7) is acted on.

19. The method as claimed in claim 18, wherein the intensity of the swirl flow of the fresh air around the cylinder axis is controlled so as to adjust the desired combustion behavior.

20. The method as claimed in claim 17, wherein an adjustable control (15) of the gas exchange valves (12, 13, 14) is used as an actuating element for controlling the combustion behavior.

21. The method as claimed in claim 20, wherein the residual exhaust gas content in the combustion chamber is changed as a manipulated variable for the control operation and the control symbols of the outlet valve (14) are correspondingly varied as an actuating element for the control operation.

22. The method as claimed in claim 17, wherein in order to set the set point value of the crank angle of the 50% mass conversion point the quantity of injected fuel is varied.

23. The method as claimed in claim 7, wherein in order to set the set point value of the crank angle of the 50% mass conversion point the fuel injection pressure is varied.

24. The method as claimed in claim 17, wherein in order to set the set point value of the crank angle of the 50% mass conversion point the injection parameters of a pilot fuel injection which precedes the main fuel injection is varied.
